(19) United States
(12) Patent Application Publication
(10) Pub. No.: US 2004/0068518 A1
(43) Pub. Date: Apr. 8, 2004

(54) Layered virtual identity system and method

(75) Inventor: Chandler Todd McDowell, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY

(21) Appl. No.: 10/264,166

(22) Filed: Oct. 3, 2002

(51) Int. Cl. G06F 7/00

(52) U.S. Cl. 707/104.1

(57) ABSTRACT

A disclosed electronic transaction system and method include a virtual identity database and a virtual identity resolver. The database comprises at least one entry, each entry corresponding to a virtual identity of an individual. The resolver receives a request containing the virtual identity from a requestor and retrieves from the database at least a portion of data stored in the entry corresponding to the virtual identity. The retrieved information is then provided to the requestor. The portion of data retrieved may be determined, at least in part, by the identity of the requestor. Typically each database entry includes a set of fields wherein each field is indicative of a subset of the individual's personal information. Some of the fields may comprise a pointer to a secondary database where the personal information corresponding to the field is located. An individual's entry in the virtual identity database may reside on the individual's personal data processing system.

### BACKGROUND

1. Field of the Present Invention

The present invention generally relates to the field of electronic transaction processing and more specifically to a system and method for implementing virtual identities to make transaction processing more efficient and to safeguard information.

2. History of Related Art

Although telephones, facsimiles, and electronic mail have provided alternative methods of communication, physical mail remains firmly entrenched as a means of corresponding for businesses as well as individuals. A conventional physical mail system 100 is illustrated in FIG. 1. In this depiction, mail items 110 through 114, from senders A, B, and C are all addressed to a Jane Doe by indicating Ms. Doe's physical mail location on the outside of the item. Items 110 through 114 are then delivered to or otherwise received by a mailing company 102 such as the U.S. Postal Service. Mailing company 102 processes items 110 through 114 by inspection of the address indicated on each item. Based on the physical address indicated on each item, mailing company 102 delivers items 110 through 114 to the physical address identified in the figure by reference numeral 115. In the illustrated example, physical address 115 to which the items are delivered is 123 Main St., Needham, Mass. 02192.

U.S. Census Bureau estimates indicate that 42 million Americans moved in the year 2000 alone. When people or other entities move, it is necessary to send everyone with whom they correspond updated mail address information. These contacts, in turn, are then required to update their address database to reflect the revised information. In the interim, mail items are delivered to old addresses or returned to the sender. If the person who has moved has informed the mailing company of the new address, items with old address information will be forwarded to the new address for a specified period of time. This means that items will be delivered to an old address where the mailing company will realize that the addressee has relocated. Depending upon the type of correspondence, the mailing company will then either return an item to the sender or forward the item to the new address on file. In either case, the process represents a significant waste of time and resources.

More generally, electronic transactions and electronic data processing are becoming increasingly common. It is now commonplace to transact business via a computer network by providing personal information to a supplier or vendor of goods and services. In addition to encountering the “wrong address” problem described above, many users are troubled by the prospect of providing personal information to each entity with whom they wish to transact business. In an effort to address these issues, virtual identity systems have been proposed. In a conventional virtual identity system, an individual (or entity) is associated with a unique identifier that serves as a proxy for personal information associated with the individual. A provider then uses the identifier to obtain the user's personal information whether it be physical address, phone number, financial records, medical records, etc. In a typical virtual identity system, the identifier provides a direct reference to a collection of personal information. The virtual identifier in such systems typically identifies a single server or a single group of servers, namely, a server operated by the provider of the virtual identifier. The identified server would contain all of the personal information associated with the virtual identifier. For security reasons, this arrangement is typically undesirable because many people are reluctant to divulge all of their personal information to a single entity. In addition to the concern of “placing all their eggs in one basket,” consumers are justifiably skeptical about providing corporations with just some of their personal information, let alone all of it. Typically, a reliable virtual identity provider would have expertise in the field of data processing networks generally and Internet applications in particular. Unfortunately, the enterprises that have devoted the most resources to and are most likely to remain in these fields do not typically inspire great confidence in their customers that personal information will remain private. It would therefore be desirable to implement a virtual identity method and system that addressed these concerns.

### SUMMARY OF THE INVENTION

The problems identified are addressed by a disclosed electronic transaction system and method that include a virtual identity server or database and a virtual identity resolver. The database, which may reside on the virtual identity server, comprises at least one entry, each entry corresponding to a virtual identity of an individual. The resolver receives a request containing the virtual identity from a requestor and forwards the virtual identity to the virtual identity server. The virtual identity server accesses the virtual identity database to retrieve at least a portion of data stored in the entry corresponding to the virtual identity. The retrieved information is then provided to the requester. The portion of data retrieved may be determined, at least in part, by the identity or entity type of the requester such that, for example, a financial institution requestor might be provided with financial information while a medical provider requester might be provided with medical information. In one embodiment suitable for enabling a virtual identity system, the personal information is not directly accessible by the virtual identity server, the virtual identity comprises a set of references or pointers that are used by the information requestor to retrieve the appropriate personal information from a secondary database. The virtual identity server might, for example, return a reference or pointer to a financial information server in response to a virtual identity request from a requestor requiring financial information. The requester may then forward the reference received from the virtual identity server to retrieve the actual information.

Typically, each virtual identity database entry may include a set of fields wherein each field is indicative of a subset of the individual's personal information. As indicated above, at least some of the fields may comprise pointers to respective secondary databases that contain the personal information corresponding to the field. In this manner, the virtual identity server may contain little or no personal information regarding the customer. Instead the virtual identity server may identify or otherwise determine a secondary database on which the requested personal information resides. In one embodiment, an individual's entry in the virtual identity database may reside on the individual's personal data processing system.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a physical mail system according to the prior art;

FIG. 2 is a block diagram of selected elements of a physical mail system employing a physical address abstraction according to one embodiment of the present invention;

FIG. 3 is a block diagram of selected elements of a physical mail system employing a layered or tiered physical address abstraction according to one embodiment of the present invention;

FIG. 4 is a block diagram of selected elements of a system employing layered virtual identification and address filtering according to one embodiment of the present invention; and

FIG. 5 is a block diagram of selected elements of a virtual identity system according to one embodiment of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention contemplates a virtual identity system suitable for use with electronic transaction or data processing systems including but not limited to physical mail systems. A participant or customer defines or is otherwise associated with a virtual identifier that comprises an abstraction of the customer's personal information. This personal information could include, for example, the customer's street address, email address, phone number, financial information including credit card numbers or bank account numbers, and medical history information. When a transaction involving the customer occurs, a provider of goods or services uses the customer's virtual identifier (virtual identity) to request personal information, typically from a virtual identity server or database on which the customer subscribes or is registered.

In one embodiment where the personal information may not reside on the virtual identity database or be accessible to the virtual identity server, the provider of goods or services (the requestor) uses virtual identity information delivered by the virtual identity server to obtain personal information corresponding to the customer in order to complete the transaction. In this embodiment, the virtual identity entry on the virtual identity database may comprise one or more fields (pointers) that indicate one or more secondary databases on which the requestor may find the personal information. In this manner, a layered virtual identity system is provided to promote additional security by enabling the virtual identity server to function without having access to the personal information. This layered approach also promotes a more open system in which the personal information is not required to reside, for example, within a single database.

Turning now to the drawings, FIGS. 2 through 4 illustrate various embodiments of a physical mail implementation of a virtual identity system contemplated by the present invention. The physical mail example is a particular application of the more generalized transaction processing system described below with respect to FIG. 5.

In FIG. 2, a virtual identity system 200 suitable for use in a physical mail application is illustrated. System 200 as depicted includes a mail company 202 that receives mail items such as items 210, 212, and 214 intended to be delivered to a customer identified on the outside of the mail item. In accordance with the present invention, mail items 210, 212, and 214 each includes a common virtual identifier 220. Virtual identifier 220 as implemented in system 200 is indicative of personal information corresponding to a person or other entity associated with the identifier. In the particular case of FIG. 2, virtual identifier 220 is indicative of physical address information associated with the addressee “Jane Doe.”

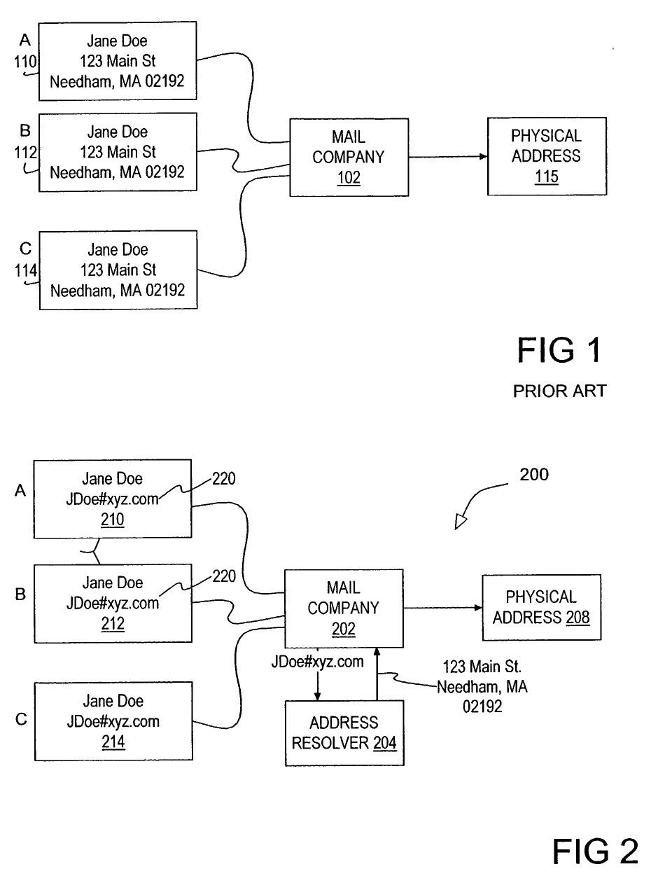

Virtual identifier 220 should be contrasted with the physical mail information that is provided on physical mail items as depicted in FIG. 1. Instead of requiring each entity that sends mail to the mail company customer (Jane Doe) to have the customer's correct physical address, system 200 enables senders of mail to use a virtual identifier that need not change each time the customer moves or otherwise alters his or her personal information. By freeing senders of mail from having to know physical mail information for each customer, system 200 potentially enables a significant reduction in the number of mail items that are sent to outdated addresses.

After items 210-214 have been addressed with virtual identifier 220, the items are delivered to or otherwise received by mail company 202. Mail company 202 may represent the U.S. Postal Service, one or more private mailing companies, or a combination thereof. Alternatively, mail company 202 may represent a large corporation that has many employees and sites. In such an environment, people may move around or change physical locations relatively frequently. In this embodiment, the corporation may employ system 200 to determine the current physical location of its employees.

Mail company 202 is generally charged with delivering parcels to individuals and businesses based on address information indicated on the outside of the parcel. In conjunction with system 200, mail company 202 includes or has access to an address resolver 204. As its name implies, address resolver 204 is configured to determine physical address information based on virtual identity information it receives. As depicted in FIG. 2, address resolver 204 may represent a single large database owned or controlled by the mail company 202 or by a third party provider. In this embodiment, address resolver 204 is configured to resolve physical address information from virtual identifier 220 by comparing or looking up the virtual identifier in a large database.

In the embodiment of system 200 depicted in FIG. 2, virtual identifier 220 is a direct reference to the corresponding raw data, i.e., to the physical address information. In this embodiment, for example, address resolver 204 includes a physical address database containing physical address information for each entry stored therein. In the alternative, layered systems, as discussed in greater detail below, may provide address resolver 204 with an indirect reference that interacts with a virtual identity server or virtual identity database.

System 200 simplifies the task facing the customer following a relocation. Instead of informing each entity that sends a customer mail, the customer in system 200 is required merely to inform a single entity of the address change. Once address resolver 204 has been updated to reflect the new address, all items processed by mailing company 202 will be delivered to the new address. Typically, updating address resolver 204 can be accomplished electronically via the Internet using a web browser or in some similar fashion thereby providing additional flexibility and efficiency to mailing system 200.

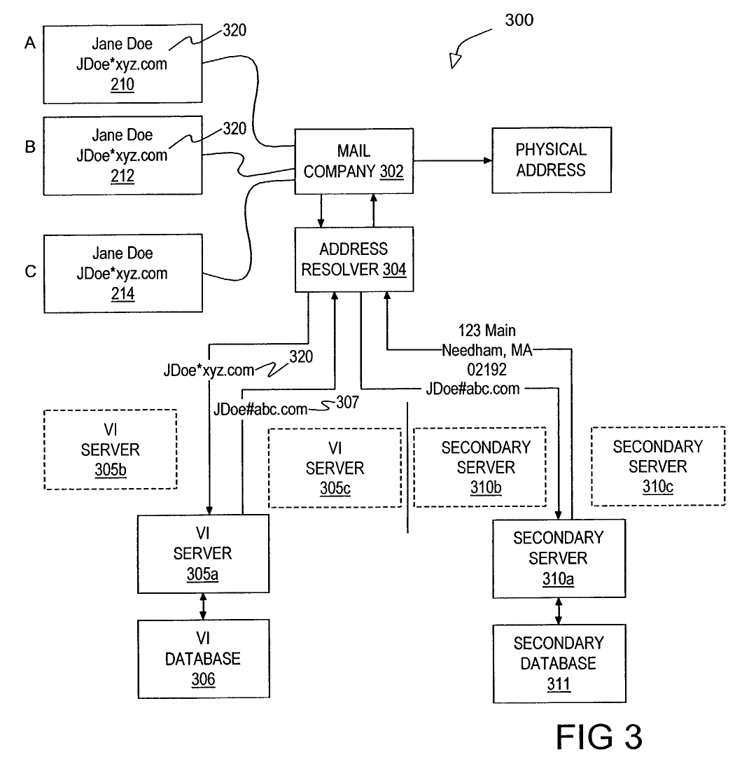

Referring now to FIG. 3, a second embodiment of a mailing system according to the present invention is presented as system 300. This embodiment of the mailing system emphasizes a layered implementation of a virtual identity system. System 300 includes a mail company 302 that receives mail items 210 through 214, each addressed with a virtual identifier 320. The virtual identifiers 320, in contrast to virtual identifiers 220 of FIG. 2, represent or identify a virtual identity entry on at least one of a set of virtual identity servers 305a, 305b, 305c (generically or collectively referred to herein as virtual identity server(s) 305). In this embodiment, address resolver 304 provides the virtual identifier 320 to a virtual identity server 305a. Virtual identity server 305a is configured to respond to receiving a virtual identifier 320 from a requestor by providing the requestor with one or more references or pointers retrieved from a virtual identity database 306. The references or pointers provided by virtual identity server 305a indicate where the requester may request the appropriate personal information.

In the depicted example, virtual identity server 305a receives a virtual identifier (JDoe*xyz.com) and returns a reference 307 (JDoe#abc.com) that is not the physical address of the addressee, but instead is a pointer indicating where to find the physical address information. (These exemplary server names are used for illustrative purposes and any similarity with the domain names of actual servers is unintended). In response to receiving reference 307 from virtual identity server 305a, address resolver 304 is configured to generate a request for physical address information corresponding to the customer based upon reference 307. Typically, reference 307 indicates the location of the corresponding personal information. The characters “#abc.com”, for example, may uniquely identify an address database (the secondary database), while the characters “JDoe” identify an entry within the secondary database. Address resolver 304 would then forward a request for physical address information to a secondary server identified by reference numeral 310a. The secondary server 310a typically includes or has access to a secondary database 311 containing the personal information of the customer, which in this case, includes the physical address information. Thus, in this embodiment, virtual identifier 320 may identify a virtual identity server and an entry within the virtual identity server's database that identifies the domain of a secondary server on which the desired information resides.

FIG. 3 illustrates multiple virtual identity servers 305a, 305b, and 305c to encompass implementations in which, for example, virtual identity services are provided by multiple vendors. In such a case, the virtual identifier 320 would indicate the location of the virtual identity server 305 as well as the appropriate virtual identity database entry at that location. In addition, FIG. 3 illustrates multiple secondary servers 310a, 310b, and 310c. These multiple secondary servers may represent different suppliers of personal information storage. Thus, for example, each secondary server 310 may represent a different supplier of physical mail information wherein server 310a is mailcompany1.com, server 310b is mailcompany2.com, and so forth. Alternatively, as discussed in greater detail with respect to FIG. 5, each secondary server 310 may represent a different type of personal information. While secondary server 310a might contain physical address information, secondary server 310b might contain financial information, for example, and secondary server 310c might contain phone number information.

The embodiment employing a secondary server 310 thus contemplates a virtual identity abstraction in which the personal information raw data may reside on databases distinct from the database in which the virtual identifier itself is resolved. Secondary database 311 may comprise a distributed database where, for example, the mailing address information for each virtual identity resides on the corresponding individual's own personal computer or other data processing device. Similarly, the virtual identity database 306 may comprise a distributed database where, for example, the virtual identity entries for each subscriber to virtual identity server 305 reside on the subscriber's own personal disk. This implementation is becoming increasingly feasible with the emergence of cable modem, DSL connections, and the like that enable personal systems to remain permanently connected to a network such as the Internet or a local area network within a corporate environment. In addition to local storage of virtual identity information, local control may be provided wherein an individual is able not only to store virtual identity information locally, but also able to edit and otherwise maintain the information and to interact with it in real-time or otherwise such that, for example, individuals may monitor and selectively grant and deny requests for their personal information.

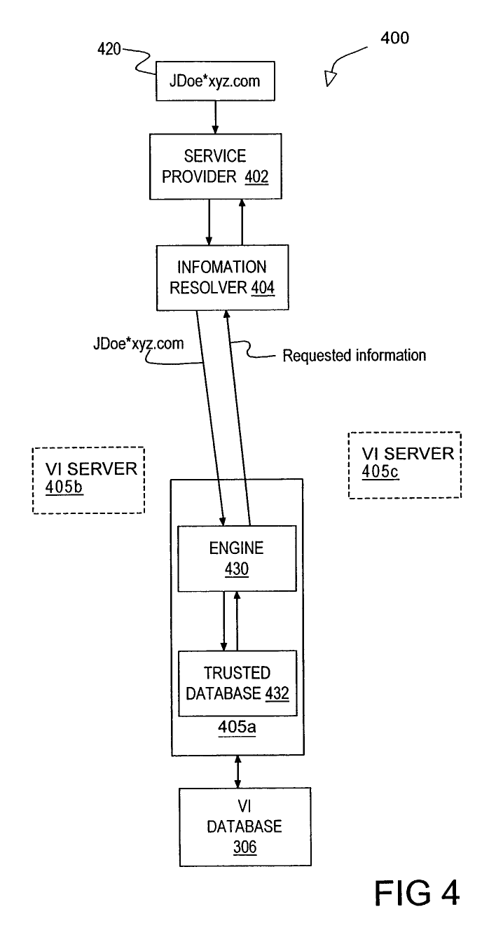

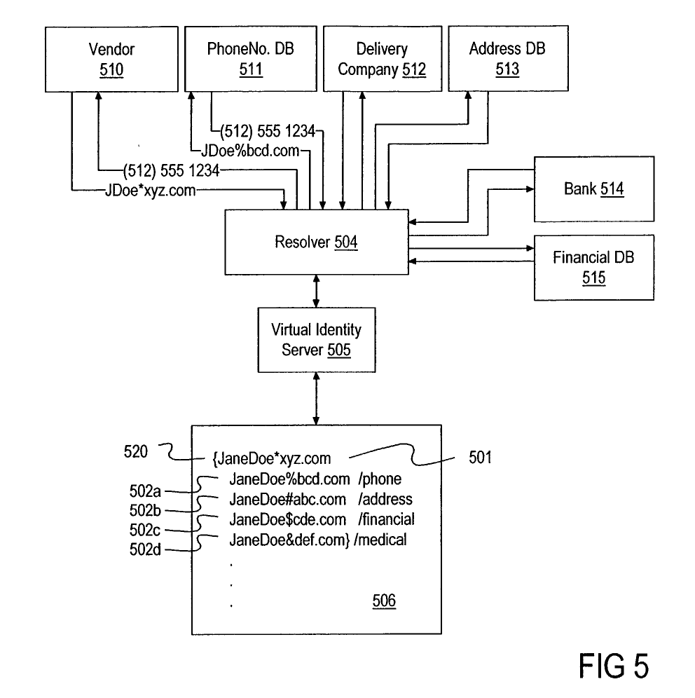

Referring to FIG. 4, another feature of a data transaction system according to the present invention is emphasized. In this embodiment, a service provider (the information requester) 402 obtains a virtual identifier 420 from a customer. Service provider 402 then communicates with an information resolver 404 to request personal information about the customer that is relevant to the corresponding transaction. If, for example, the customer is trying to use a credit card, address resolver 404 may request financial information corresponding to virtual identifier 420. Information resolver 404, like address resolver 304 in FIG. 3, interprets virtual identifier information 420 to generate a request to one of multiple virtual identity servers 405a through 405c (server(s) 405). In system 400, however, each virtual identity server 405 may include an engine 430 and a trusted database 432 that enables virtual identity server 405 to make decisions about whether to return the requested information to resolver 404. This embodiment beneficially provides system 400 with the ability to filter requests from untrusted or undesirable sources. With respect to a mailing system, for example, engine 430 and trusted database 432 may enable information resolver 404 to filter requesters, such as “junk” mail providers, so that such requestors would not receive personal information. In this embodiment, each customer may include within its corresponding database 405 a list of requesters to whom the customer does or does not wish to supply personal information. If a particular requestor is determined by virtual identity server 405 to be a requestor to whom the customer does not wish to provide personal information, server 405 may decline to provide resolver 404 with the requested personal information.

In the embodiments depicted in FIG. 3 and FIG. 4, in which multiple databases servers 305 and 405 co-exist, the corresponding databases could be implemented in various ways. In one embodiment, virtual identity databases 306 may reside on the personal computer of each corresponding mailing company customer. In this embodiment, personal data such as physical address information is maintained locally by each user thereby potentially enhancing the security of the information. Requests for physical address information generated by resolvers 304 and 404 are ultimately delivered to the customer's personal system by way of virtual identity servers 305 and 405. In other embodiments, the virtual identity databases 306 may represent commercial databases that store personal information for a large number of individuals who may subscribe or otherwise pay a fee for the privilege of storing their virtual identifiers on the corresponding site's database.

Referring now to FIG. 5, a more generalized depiction of an electronic transaction processing system 500 employing virtual identities is depicted. System 500 typically includes a virtual identity server 505 and its corresponding database 506, a virtual identity resolver 504, and multiple information databases represented in FIG. 5 by a phone number database 511, an address database 513, and financial database 515. In this depiction, a virtual identifier 520 associated with Jane Doe includes various identifier fields 502a through 502d (field(s) 502). These fields 502 may comprise or reference personal information about Jane Doe including, but not limited to, Jane Doe's phone numbers, address, financial information such as credit card numbers and bank account numbers, and medical information. In an embodiment not depicted, fields 502 may comprise the corresponding personal information (raw data). Thus, for example, the address field 502b may include Jane Doe's current mailing address. In the depicted embodiment, fields 502 comprise pointers or references to the corresponding information server or database corresponding information such that, for example, Jane Doe's address information could be located on a secondary server (513) that is distinct from virtual identity server 505. Moreover, the secondary server for her address information could be distinct from the secondary server for her financial information. This embodiment would enable the selective deployment of personal information among several databases.

Virtual identity resolver 504, although depicted as a single entity, may comprise multiple entities executing on multiple servers. Resolver 504 is configured to receive requests for personal information from various vendors of goods and services exemplified in FIG. 5 by a retailer or vendor 510, a delivery company 512, and a bank 514. Virtual identity resolver 504 is configured to receive requests from various service providers where each request is associated with a particular customer identified by the customer's virtual identity. Virtual identity resolver 504 forwards virtual identity information to a virtual identity server 505. The virtual identity server 505 returns at least a portion of an entry in virtual identity database 506 that corresponds to the virtual identifier. The determination of which portion(s) of a virtual identifier entry to return may be based upon, for example, the identity or type of the requestor. In an exemplary transaction, Jane Doe purchases an item from vendor 510. In conjunction with this transaction, vendor 510 requires payment verification from a bank 514 and employs a delivery company 512 to deliver the item to the customer.

Initially, vendor 510 may obtain the customer's virtual identifier 520 (i.e., JaneDoe*xyz.com) from the customer as part of the customer's purchase transaction. Vendor 510 may then request personal information corresponding to the virtual identifier by providing virtual identity 520 to resolver 504, which forwards the request to virtual identity server 505. In response, virtual identity server 505 may retrieve from a virtual identity database 506, for example, the phone field 502a, the address field 502b, and the financial field 502c in the entry corresponding to virtual identity 520 and return the retrieved information to resolver 504. In a layered virtual identity embodiment, the fields 502a, 502b, and 502c represent pointers or references to respective databases 511, 513, and 515. Resolver 504 will query phone number database 511 using field 502a, address database 513 using 502b, and so forth, to retrieve the customer's personal information and return this information to vendor 510. Vendor 510 may then use the appropriate fields to obtain financial authorization from bank 514 and to provide shipping company 512 with a street address.

In one embodiment, resolver 504 selectively provides personal information to only those entities that need the information. System 500, for example, may be configured to provide vendor 510 with only the customer's phone number, delivery company 512 with the customer's address, and bank 514 with the customer's credit card number. In this embodiment, resolver 504 is configured to determine what portion of personal information 501 is provided to a requester based on the requestor's identify. Thus, for example, the customer might complete a transaction with vendor 510 without ever revealing his or her physical address or credit card number to vendor 510.

It will be apparent to those skilled in the art having the benefit of this disclosure that the present invention contemplates a layered virtual identity system and method in which personal information may be detached from the virtual identity server. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. An electronic transaction system, comprising:
a virtual identity server having access to a virtual identity database comprising at least one entry, each entry corresponding to a virtual identity of an individual;
a virtual identity resolver configured to receive a request containing the virtual identity from a requestor and further configured to access the virtual identity server to retrieve from the database at least a portion of data stored in the entry corresponding to the virtual identity; and
means for providing the retrieved information to the requestor.

2. The system of claim 1, wherein the portion of data retrieved is determined, at least in part, by the identity of the requester.

3. The system of claim 1, wherein each database entry is further characterized as having a set of fields wherein each field is indicative of a subset of personal information corresponding to the individual.

4. The system of claim 3, wherein at least one field comprises a pointer to a secondary database where the personal information corresponding to the field is located.

5. The system of claim 4, wherein the resolver is configured to retrieve at least one field identifier from the database and further configured to request the corresponding personal information from a server corresponding to the field identifier.

6. The system of claim 4, wherein each field comprises a pointer to a corresponding secondary database wherein a secondary database corresponding to a first field is distinct from a secondary database corresponding to a second field.

7. The system of claim 1, wherein at least a portion of the virtual identity database resides on a data processing system of the individual.

8. An electronic transaction method suitable for use with a virtual identity database comprising at least one entry, each entry corresponding to a virtual identity of an individual, comprising:
receiving a request containing the virtual identity from a requestor;
retrieving from the database a portion of data stored in the entry corresponding to the virtual identity wherein the portion of data retrieved is determined, at least in part, by the identity of the requestor; and
providing the retrieved information to the requestor.

9. The method of claim 8, wherein each database entry is further characterized as having a set of fields wherein each field is indicative of a subset of personal information corresponding to the individual.

10. The method of claim 9, wherein at least one field comprises a pointer to a secondary database where the personal information corresponding to the field is located.

11. The method of claim 10, further comprising retrieving at least one field identifier from the database and requesting the corresponding personal information from a server corresponding to the field identifier.

12. The method of claim 8, wherein at least a portion of the virtual identity database resides on a data processing system of the individual.

13. A virtual identity system, comprising:
a virtual identity database comprising at least one virtual identity entry, wherein each entry corresponds to a virtual identity and further wherein each virtual identity entry includes information indicative of a corresponding individual's personal information including, at least, the individual's mailing address;
responsive to recognizing a virtual identity, means for accessing the virtual identity database to retrieve at least a portion of the information in the entry corresponding to the virtual identity wherein the retrieved information includes the information indicative of the individual's mailing address; and
means for providing the retrieved information including the mailing address to a requestor of the information.

14. The system of claim 13, wherein the means for accessing the database comprises an address resolver configured to retrieve the information indicative of the individual mailing address.

15. The system of claim 14, wherein the address resolver is configured to determine a server wherein the database resides based at least in part upon the virtual identifier.

16. The system of claim 13, wherein the virtual identity database includes the mailing address of the individual associated with virtual identifier.

17. The system of claim 13, wherein the virtual identity database includes a pointer to a secondary database that includes the address information of the individual.

18. The system of claim 13, wherein an individual's virtual database entry resides on a data processing system of the individual.

19. The system of claim 13, wherein the address resolver includes an engine configured to decide whether to return the retrieved information to the requestor.

20. The system of claim 19, further comprising a trusted database and wherein the engine decides whether to return the retrieved information based on a match between an identity of the requestor and an entry in the trusted database.
